(19) United States
(12) Patent Application Publication
(10) Pub. No.: US 2015/0104232 A1
(43) Pub. Date: Apr. 16, 2015

(54) IMAGE FORMING APPARATUS

(71) Applicant: CANON KABUSHIKI KAISHA, Tokyo (JP)

(72) Inventor: Fumihiko Hayayumi, Abiko-shi (JP)

(21) Appl. No.: 14/509,848

(22) Filed: Oct. 8, 2014

(30) Foreign Application Priority Data
Oct. 10, 2013 (JP) 2013-212750

(51) Int. Cl. G03G 15/00

(52) U.S. Cl. CPC G03G 21/1647
USPC 399/393

(57) ABSTRACT

An image forming apparatus which includes: a containing portion configured to contain a sheet on which an image is to be formed; a pair of guide rails facing in an up-down direction, the guide rails guiding a slide movement of the containing portion; an engaging portion provided in the guide portion that is guided by the guide rails; a first stopper which abuts the engaging portion so as to regulate removal of the containing portion from an apparatus main body; and a second stopper, wherein the first stopper is movable in a sliding direction.

### BACKGROUND OF THE INVENTION

1. Field of the Invention

The present invention relates to an image forming apparatus which forms an image on a sheet.

2. Description of the Related Art

An image forming apparatus, such as a printer and a copier, includes a containing cassette as a containing portion in which sheets are contained in a stacked manner. The sheet is fed from the containing cassette and an image is formed on the sheet. When the containing cassette is replenished with sheets, the containing cassette is pulled from an apparatus main body of the image forming apparatus. Further, it is necessary to remove the containing cassette from the apparatus main body for, for example, the maintenance of the apparatus.

A configuration provided with a stopper for regulating removal of the containing cassette from the apparatus main body when the containing cassette is pulled from the apparatus main body has been proposed. By regulating the pulling of the containing cassette by the stopper on the way, replenishment of the sheets and the like may be performed easily. By releasing the stopper and removing the containing cassette from the apparatus main body, maintenance and the like may be performed easily. Japanese Patent No. 3516376 proposes a configuration in which a user lifts a containing cassette and releases regulation of a stopper, whereby the containing cassette becomes removable from the apparatus main body. Japanese Patent No. 3571910 proposes a configuration in which a stopper for regulating removal is swingably attached to a containing cassette and, when a user manually moves the stopper to a position at which regulation is released, the containing cassette becomes removable.

In the configuration of Japanese Patent No. 3516376, when the user lifts the containing cassette, the containing cassette becomes removable. In this apparatus, however, there is a possibility that the containing cassette is removed from the apparatus main body even when the user does not intend to remove the containing cassette. In the configuration of Japanese Patent No. 3571910, there is a possibility that the user makes the stopper swing unintentionally and the containing cassette may be removed.

In a case in which the containing cassette is unintendedly removed in this manner, it is possible that, for example, the user will be at a loss how to attach the removed containing cassette to the apparatus main body again. It is also possible that the user breaks the apparatus in an attempt to attach the containing cassette by force without knowing how to attach the same.

### SUMMARY OF THE INVENTION

The present invention aims to reliably prevent removal, which is not intended by a user, of a containing cassette as a containing portion.

An image forming apparatus of the present invention includes a containing portion configured to contain a sheet on which an image is to be formed and configured to be slidably supported by an apparatus main body, a pair of guide rails provided in the apparatus main body and facing each other in an up-down direction, the guide rails being configured to guide a slide movement of the containing portion, a guide portion provided in the containing portion and guided by the pair of guide rails between the pair of guide rails, an engaging portion provided at an end portion in a sliding direction of the guide portion, the engaging portion including a projecting portion projecting upward and a projecting portion projecting downward, a first stopper provided to project from one guide rail of the pair of guide rails toward the other guide rail of the pair of guide rails, and configured to abut the engaging portion to regulate removal of the containing portion from the apparatus main body, and a second stopper provided to project from the other guide rail toward the one guide rail, and configured to abut the engaging portion to regulate removal of the containing portion from the apparatus main body, wherein the first stopper is movable in a sliding direction from a position at which removal of the containing portion from the apparatus main body is regulated where a distance between the first stopper and the second stopper is shorter than a thickness in the up-down direction of the engaging portion to a position at which removal of the containing portion from the apparatus main body is released where the distance between the first stopper and the second stopper is longer than the thickness of the engaging portion.

Further features of the present invention will become apparent from the following description of exemplary embodiments with reference to the attached drawings.

### BRIEF DESCRIPTION OF THE DRAWINGS

FIGS. 1A to 1C illustrate an image forming apparatus according to an embodiment of the present invention.

FIGS. 2A and 2B are perspective views of a first embodiment of the present invention.

FIGS. 3A to 3C are explanatory views illustrating an operation of the first embodiment of the present invention.

FIGS. 4A and 4B are perspective views of a second embodiment of the present invention.

FIGS. 5A to 5C are explanatory views illustrating an operation of the second embodiment of the present invention.

FIGS. 6A and 6B are perspective views of a third embodiment of the present invention.

FIGS. 7A and 7B are perspective views of a containing cassette.

FIGS. 8A to 8C are diagrams illustrating Comparative Example.

### DESCRIPTION OF THE EMBODIMENTS

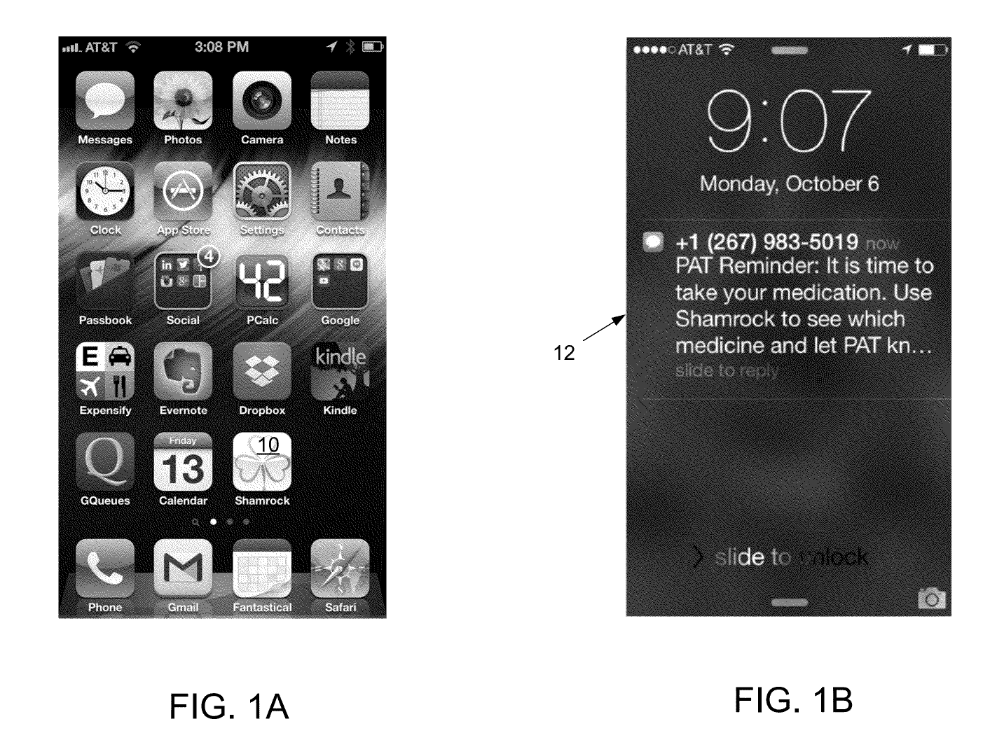

FIGS. 1A to 1C illustrate an image forming apparatus 100 as an exemplary embodiment according to the present invention. FIG. 1A is a front view of the image forming apparatus 100, FIG. 1B is a front view of the image forming apparatus 100 in a state in which a containing cassette 1 is removed, and FIG. 1C is a perspective view of the image forming apparatus 100 in a state in which the containing cassette 1 is pulled.

A containing cassette 1 as a containing portion which stores sheets in a stacked state is provided in the image forming apparatus 100. The containing cassette 1 may be pulled in the front side of an apparatus main body 102 by a pulling device 10. The containing cassette 1 is provided so that paper sheets, OHT sheets and the like may be placed by a user as sheets on which images are to be formed. The containing cassette 1 is replenished with sheets in a state in which the containing cassette 1 is pulled in the front side of the apparatus as illustrated in FIG. 1C. In the present embodiment, three containing cassettes 1 of the same configuration are arranged in an up-down direction.

The sheets contained in the containing cassette 1 are fed to the apparatus main body 102 and an image is formed thereon by the image forming unit 101. For example, an image is formed on the sheet in accordance with image information read by an image reading unit provided in the image forming apparatus 100 or in accordance with image information transmitted to the image forming apparatus 100 via an external connection cable.

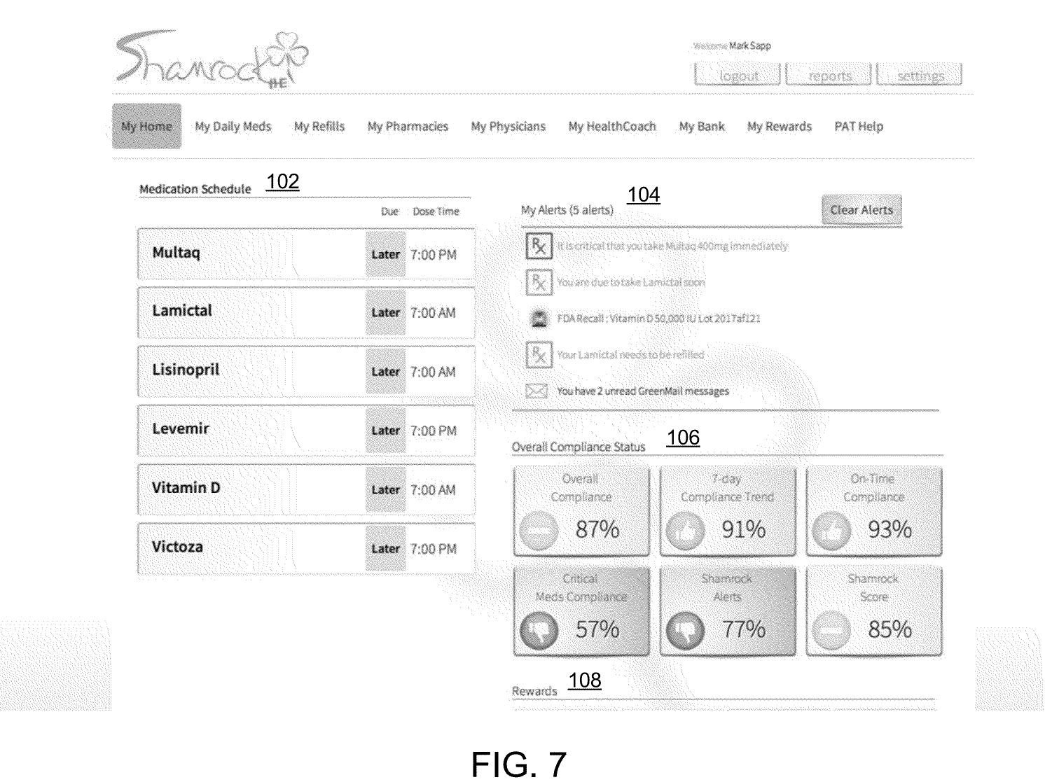

As illustrated in FIGS. 7A and 7B, guide members (i.e., guide portions) 2 are provided at both sides of the containing cassette 1 (i.e., end portions of a direction that crosses a sliding direction). The guide members 2 are supported by the pulling device 10 and extend along side surfaces of the containing cassette 1. At an end portion of the guide member 2, as illustrated in FIG. 7B which is an enlarged view of 103 of FIG. 7A, a cassette stopper 3 is provided. The cassette stopper 3 is formed as an engaging portion that includes a first projecting portion 3a protruding upward and a second projecting portion 3b protruding downward.

Next, the pulling device 10 that is provided in the apparatus main body 102 and supports the containing cassette 1 in a pullable manner will be described in detail.

### First Embodiment

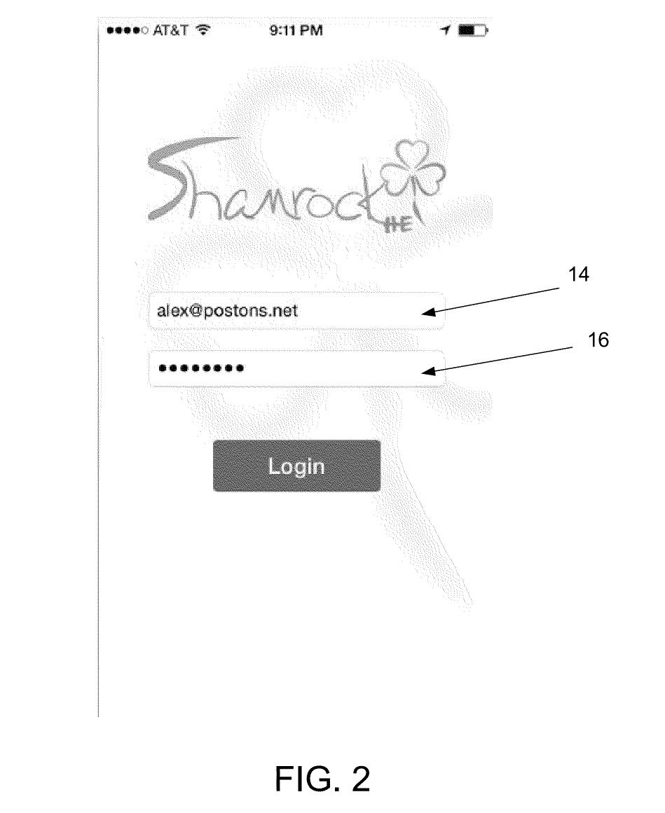

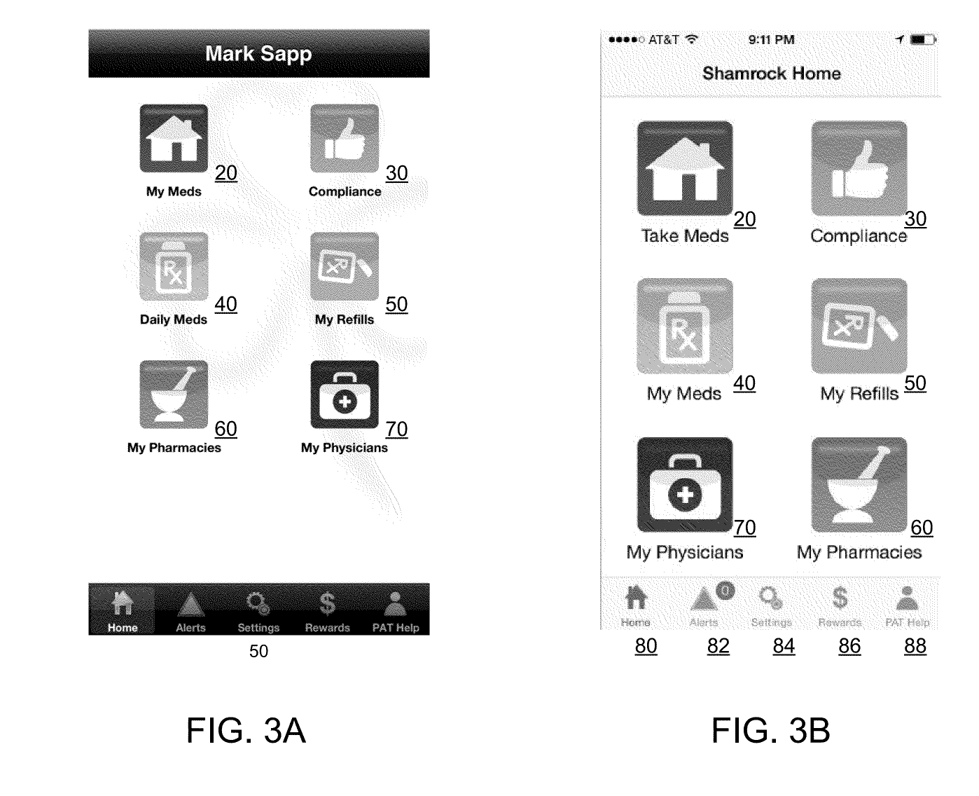

Hereinafter, a pulling device 10 according to a first embodiment will be described. FIGS. 2A and 2B are perspective views illustrating a configuration of the pulling device 10 disposed in the apparatus main body 102. FIGS. 3A, 3B and 3C are explanatory views of an operation of the pulling device 10.

As illustrated in FIGS. 2A and 2B, the pulling device 10 includes guide rails 4 as guide units disposed to face each other at both sides of the containing cassette 1. The guide rails 4 extend in a direction in which the containing cassette 1 is pulled, and slidably support the containing cassette 1 in the sliding direction. Each guide rail 4 includes an upper guide rail portion 41, a lower guide rail portion 42, and a side surface portion 43 that connects the upper guide rail portion 41 and the lower guide rail portion 42. The guide rail 4 has a substantially U-shaped cross section.

The containing cassette 1 is attached to the pulling device 10 such that the guide member 2 is disposed between the upper guide rail portion 41 and the lower guide rail portion 42 (see FIGS. 3A to 3C). That is, the guide rail 4 supports the guide member 2 provided in the containing cassette 1, and guides the containing cassette 1 when it is pulled or attached/detached.

In particular, when the containing cassette 1 is pulled, the guide member 2 provided in the containing cassette 1 is slidably guided in a horizontal direction. At this time, a movement of the guide member 2 provided in the containing cassette 1 in the up-down direction is regulated by the upper guide rail portion 41 and the lower guide rail portion 42 of the guide rail 4. In this manner, the containing cassette 1 is pulled from the apparatus main body 102 while being guided by a pair of guide rails: the upper guide rail portion 41 and the lower guide rail portion 42.

A rotatable guide roller 45 that supports the guide member 2 of the containing cassette 1 is disposed in the lower guide rail portion 42.

The guide rail 4 includes a sliding portion in which the guide member 2 slides against the guide rail 4 disposed across the entire area from the front side to the back side of the apparatus main body 102. A rail stopper 5 is provided in the guide rail 4 on the front side of the apparatus main body. The rail stopper 5 is disposed at a position to abut (i.e., engage) the cassette stopper 3 when the containing cassette 1 is pulled to a sufficient amount so that the largest sized sheet may be placed on the containing cassette 1. In this manner, the maximum pulling amount of the containing cassette 1 may be controlled by the rail stopper 5.

The rail stopper 5 is formed by a movable rail stopper 5b as a first stopper and a fixed rail stopper 5a as a second stopper that are disposed to face each other.

The fixed rail stopper 5a is provided to project downward (i.e., toward the lower guide rail portion 42 which is a second guide rail) from the upper guide rail portion 41 which is a first guide rail of the pair of guide rails.

The movable rail stopper 5b is provided to project upward (i.e., toward the upper guide rail portion 41 which is the first guide rail) from the lower guide rail portion 42 which is the second guide rail. The movable rail stopper 5b is detachably, i.e., movably, attached to the lower guide rail portion 42. A first notch 191 and a second notch 192 are formed in the lower guide rail portion 42.

In normal use, the movable rail stopper 5b is attached to a stopper position illustrated in FIGS. 2A and 3A. When the movable rail stopper 5b is in the stopper position, the movable rail stopper 5b fits into and engages the first notch 191. Since the movable rail stopper 5b engages the first notch 191, the movable rail stopper 5b is locked to regulate a movement of the containing cassette 1 in the direction in which the containing cassette 1 is pulled.

In this case, when the containing cassette 1 is pulled to the stopper position where the pulling amount becomes the maximum, the movement of the containing cassette 1 is regulated in the following manner. That is, as illustrated in FIG. 3A, the cassette stopper 3 as the engaging portion provided at the end portion of the guide member 2 of the containing cassette 1 abuts the fixed rail stopper 5a and the movable rail stopper 5b. Here, the maximum thickness of the cassette stopper 3 in the up-down direction is set to t. The maximum thickness of the cassette stopper 3 as the engaging portion in the up-down direction is a distance between an upper surface of the first projecting portion 3a and a lower surface of the second projecting portion 3b. In the state illustrated in FIG. 3A, the maximum thickness t and a distance between the movable rail stopper 5b and the fixed rail stopper 5a are set so that the shortest distance T1 between the movable rail stopper 5b and the fixed rail stopper 5a becomes smaller than the maximum thickness t. Therefore, since the cassette stopper 3 is not able to pass through between the rail stoppers, pulling of the containing cassette 1 is regulated. Therefore, the containing cassette 1 is not removed from the apparatus main body 102.

Next, when the containing cassette 1 is removed from the apparatus main body 102, an operator who performs maintenance of the apparatus first moves the movable rail stopper 5b in the arrow 193 direction (see FIG. 2A) and releases the engagement between the movable rail stopper 5b and the first notch 191. The operator then slidingly moves the movable rail stopper 5b in the direction of arrow C, as illustrated in FIG. 2B to a release position provided on the side in a direction in which the containing cassette 1 is pulled. Next, the operator pushes the movable rail stopper 5b into the direction opposite to the direction of arrow 193 so as to fit the movable rail stopper 5b into the second notch 192. Since the movable rail stopper 5b engages the second notch 192, the movable rail stopper 5b is locked so as not to move in the direction in which the containing cassette 1 is pulled.

In this case, when the containing cassette 1 is pulled, the cassette stopper 3 first abuts the fixed rail stopper 5a, but does not abut the movable rail stopper 5b (see FIG. 3B). Further, the shortest distance T2 between the movable rail stopper 5b and the fixed rail stopper 5a is set to be sufficiently long with respect to the maximum thickness t of the cassette stopper 3. Therefore, as illustrated in FIGS. 3B and 3C, since the cassette stopper 3 may pass through between the fixed rail stopper 5a and the movable rail stopper 5b, the containing cassette 1 may be removed from the apparatus main body 102.

That is, when the containing cassette 1 is to be removed from the apparatus main body 102 for, for example, the maintenance of the apparatus, the front side of the containing cassette 1 is lifted in the direction of B as illustrated in FIG. 1C in a state in which the containing cassette 1 has been pulled to the maximum. When the containing cassette 1 is further pulled in this state in which the containing cassette 1 is inclined, the containing cassette 1 may be removed from the apparatus main body 102 without being regulated by the rail stoppers 5a and 5b.

Here, the release position of the movable rail stopper 5b illustrated in FIG. 2B is set to be separated from a stop position illustrated by FIG. 2A. Therefore, if the movable rail stopper 5b is attached to the release position, the containing cassette 1 may be detached and attached easily. Therefore, highly reliable stopper configuration and high maintainability may be achieved at the same time.

### Comparative Example

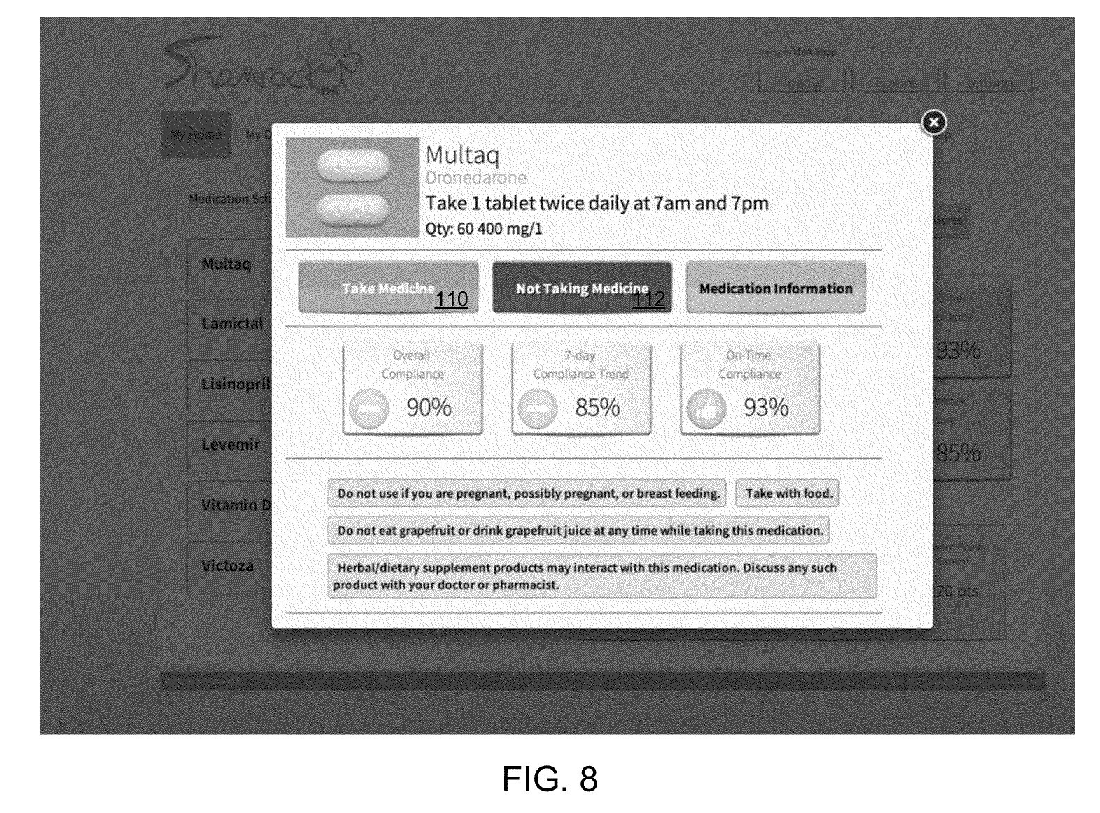

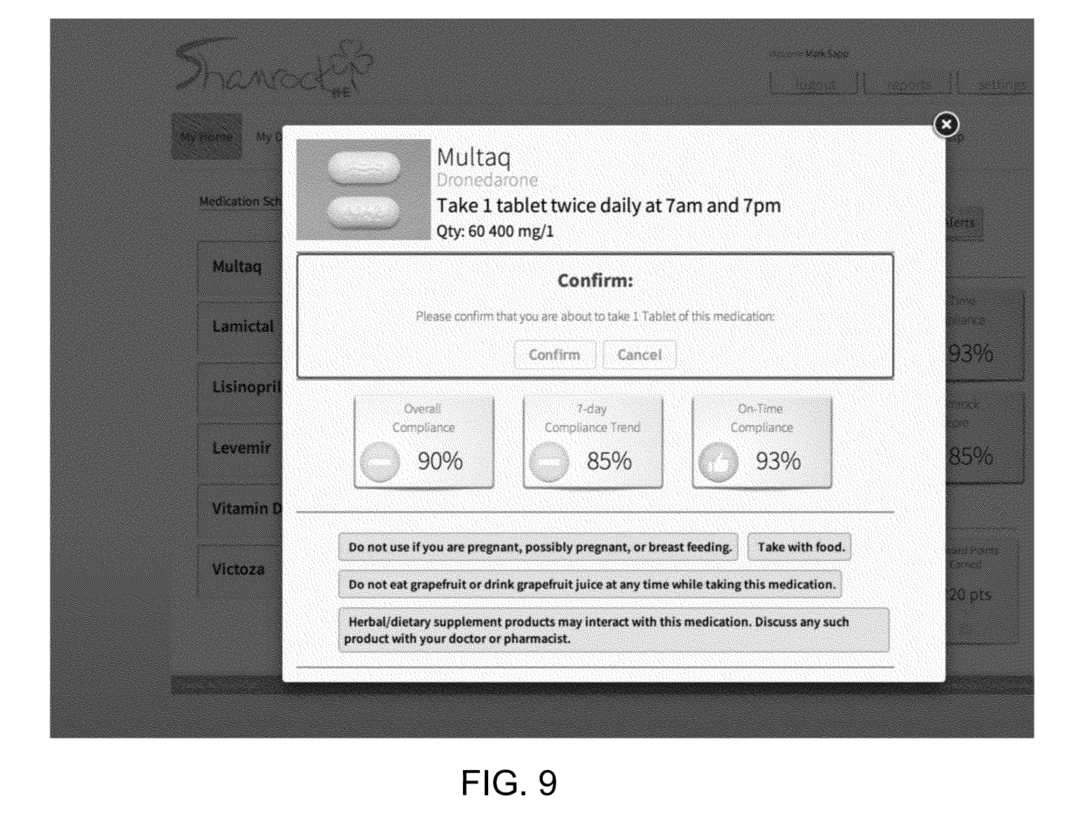

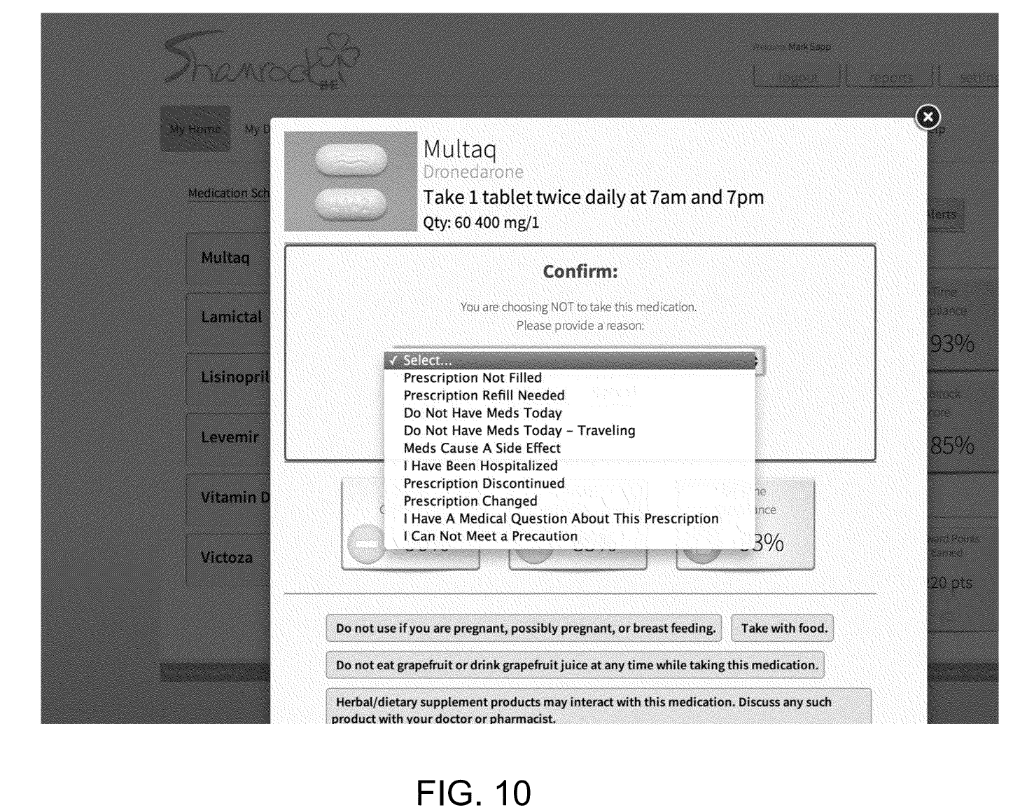

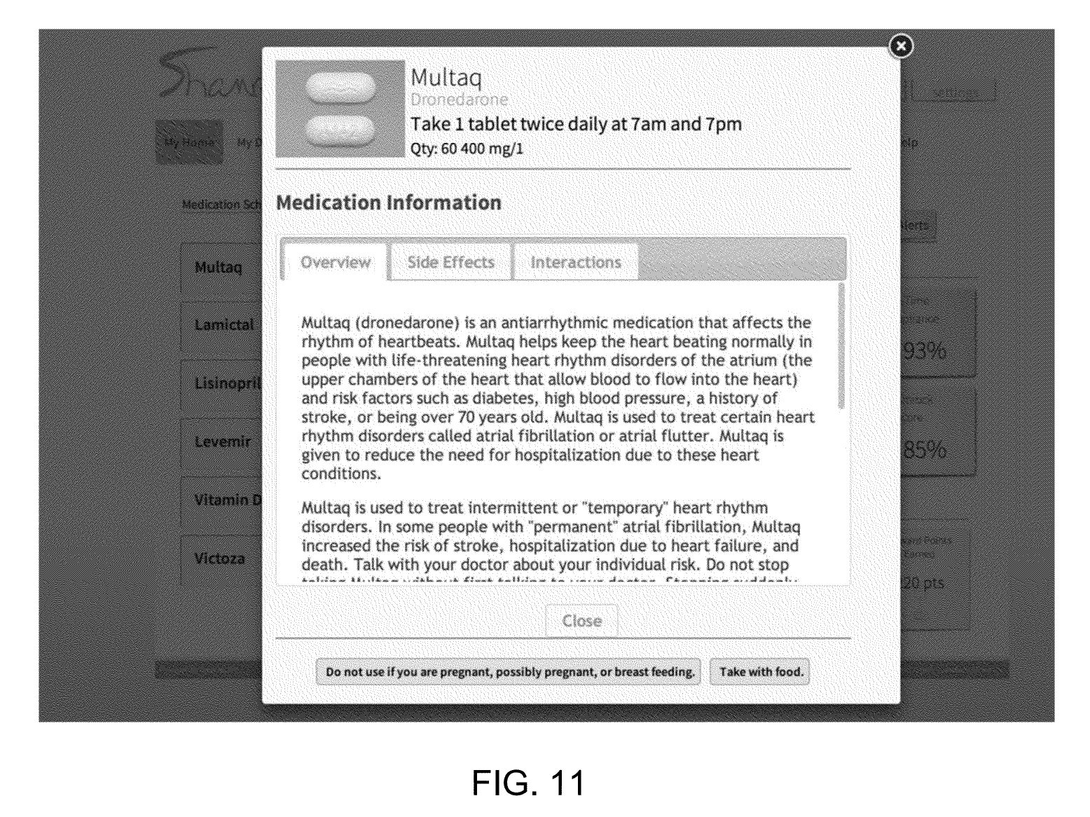

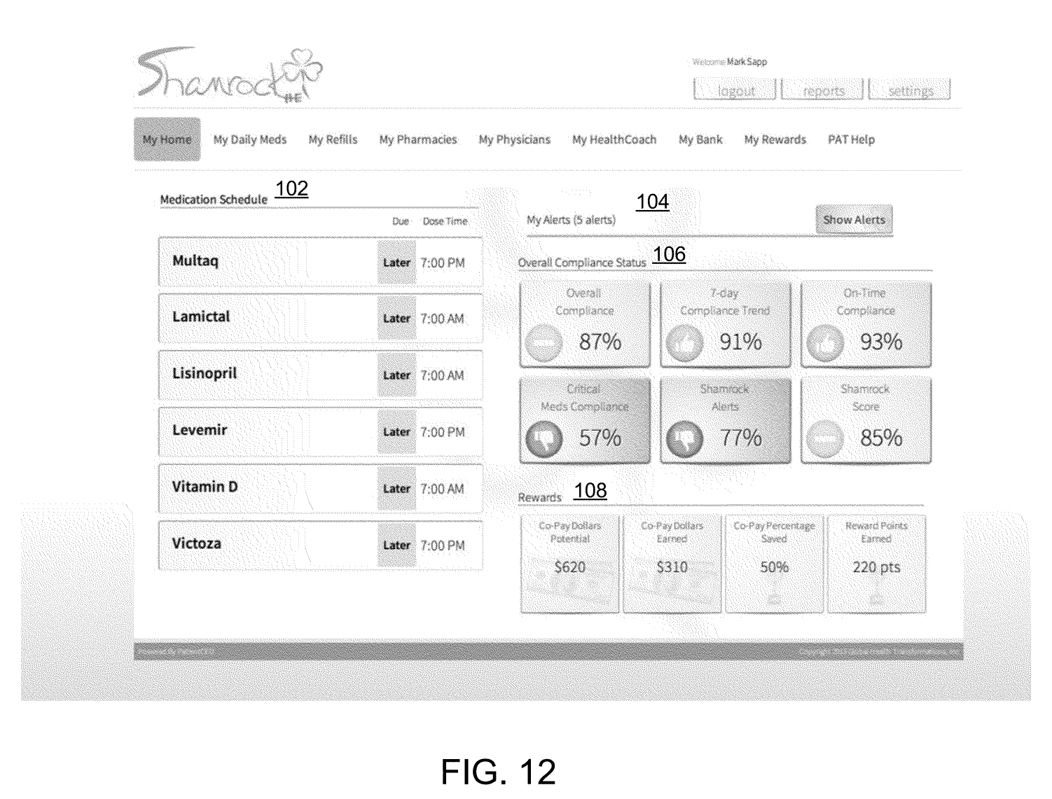

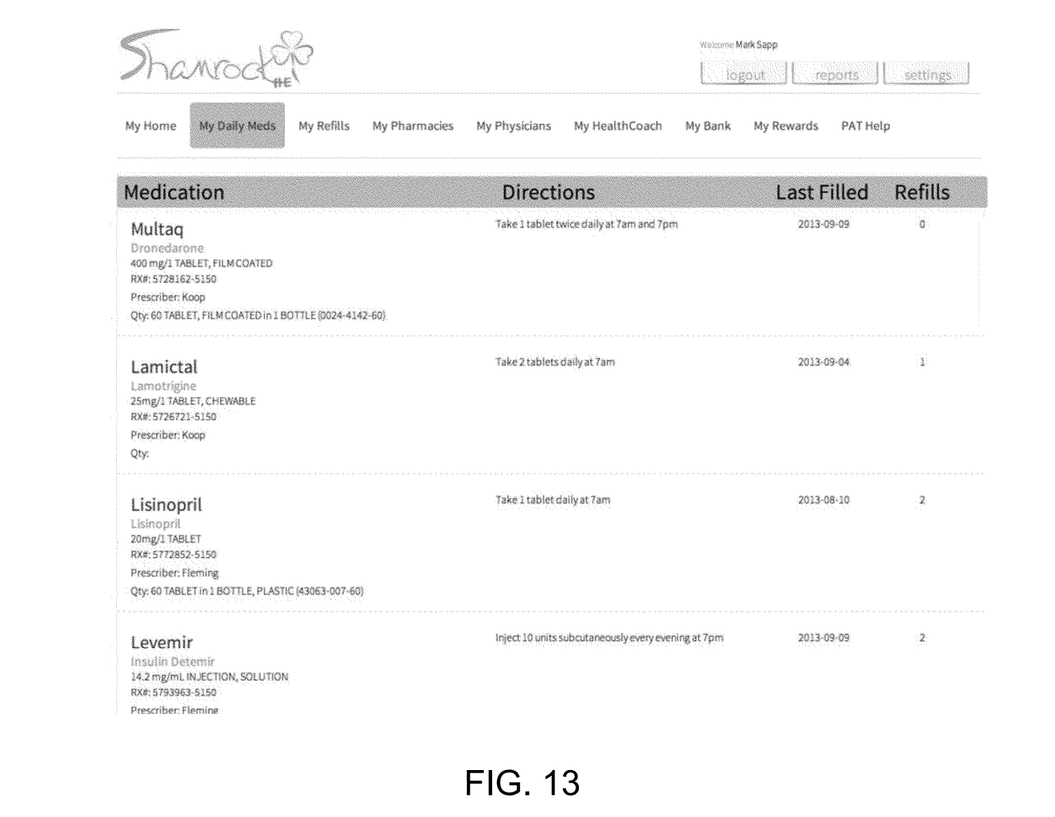

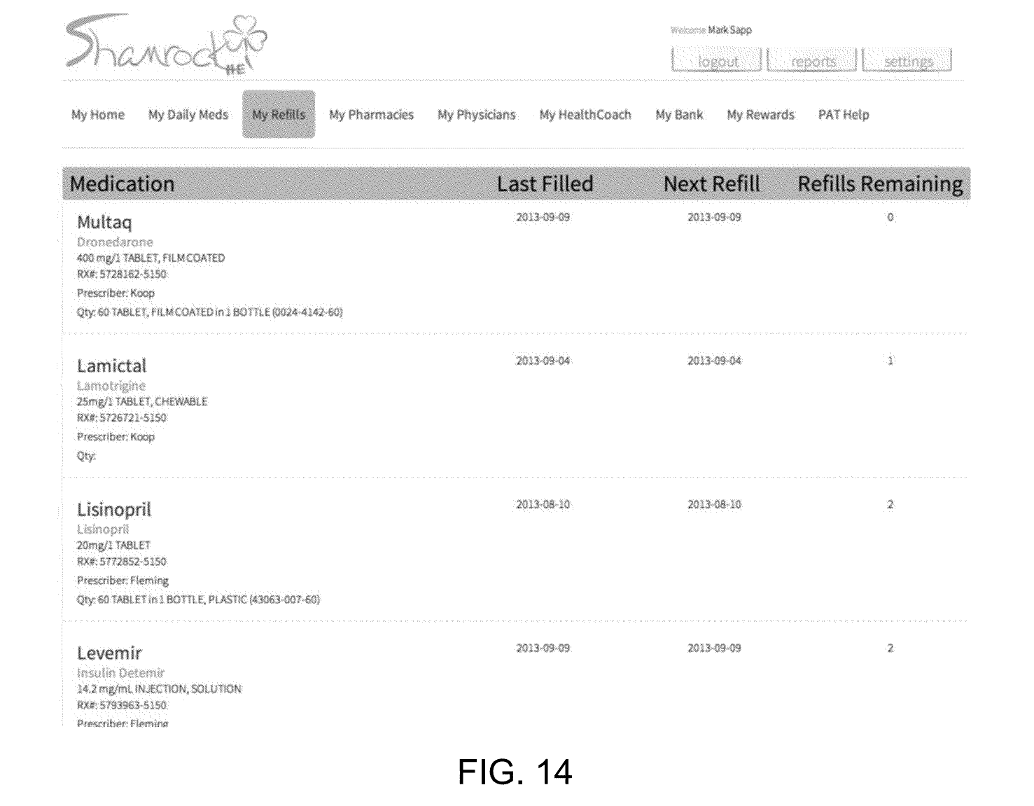

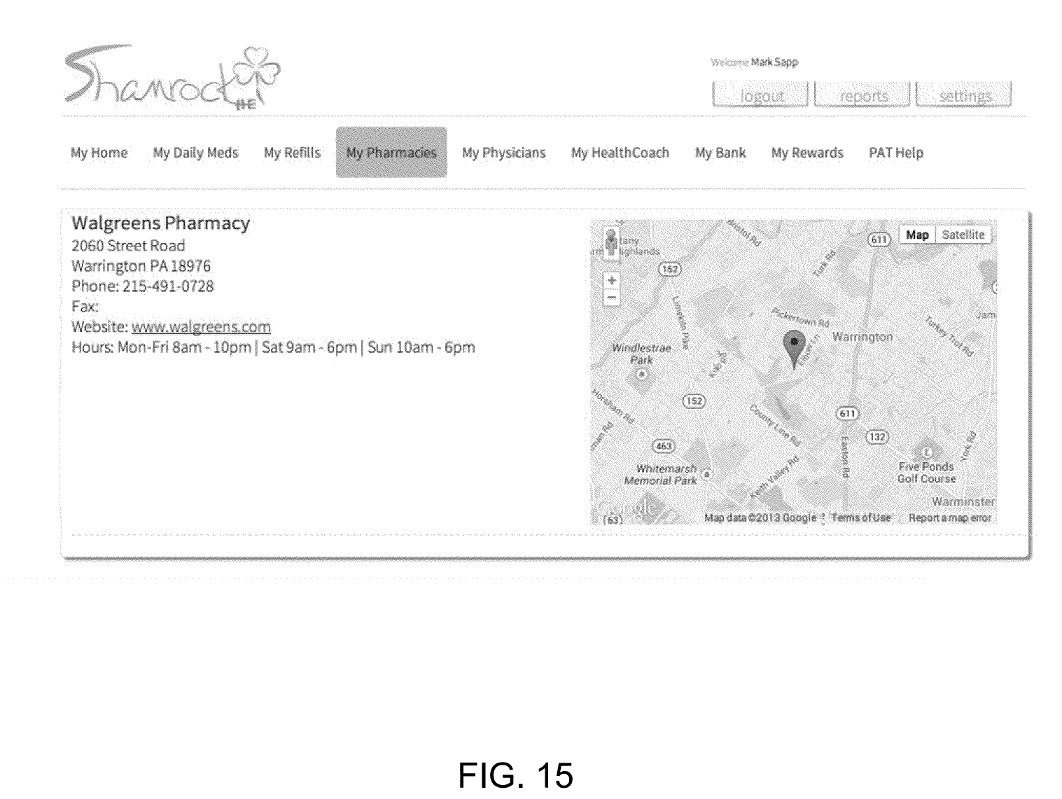

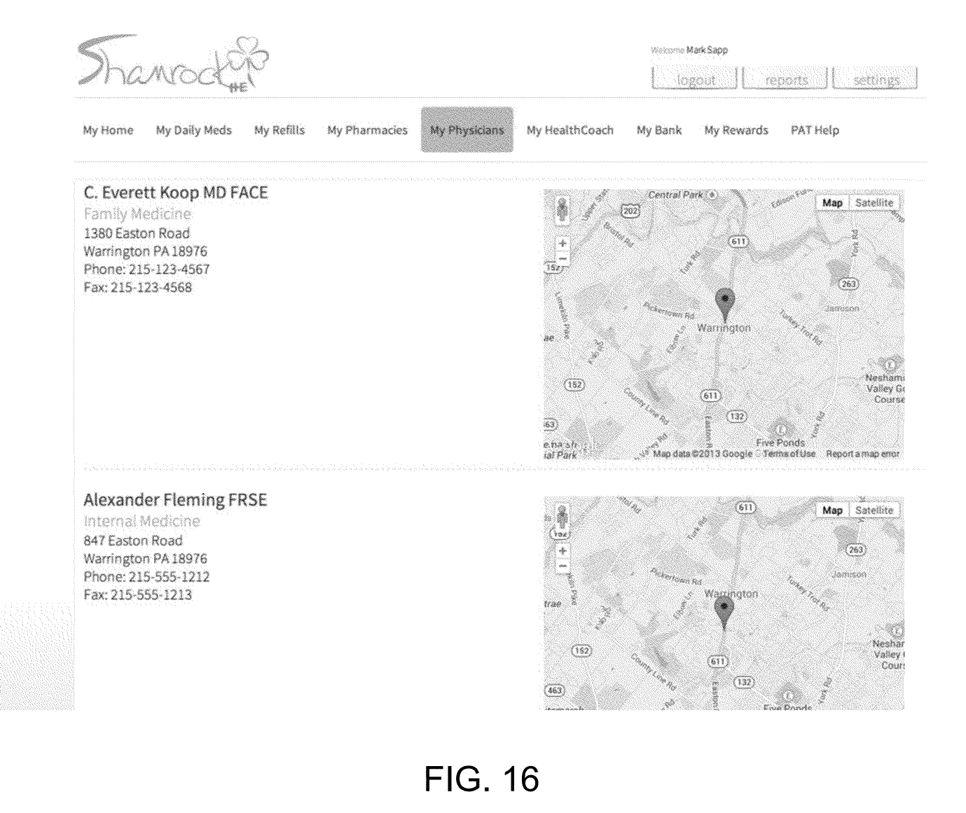

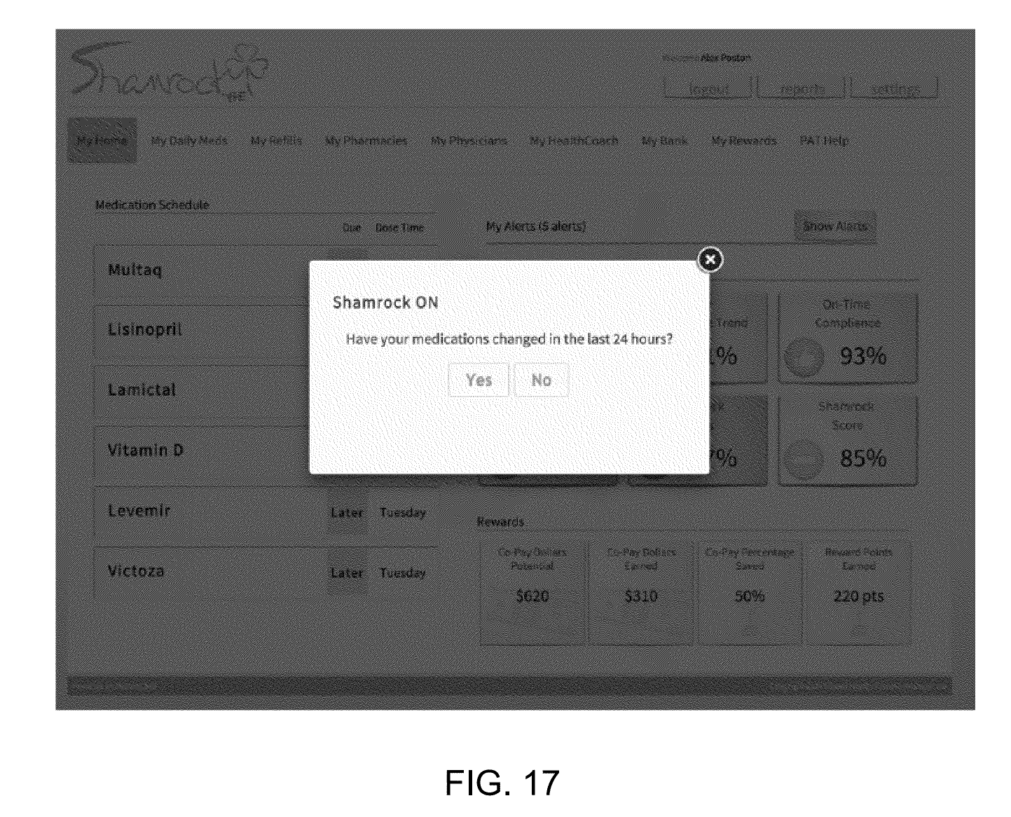

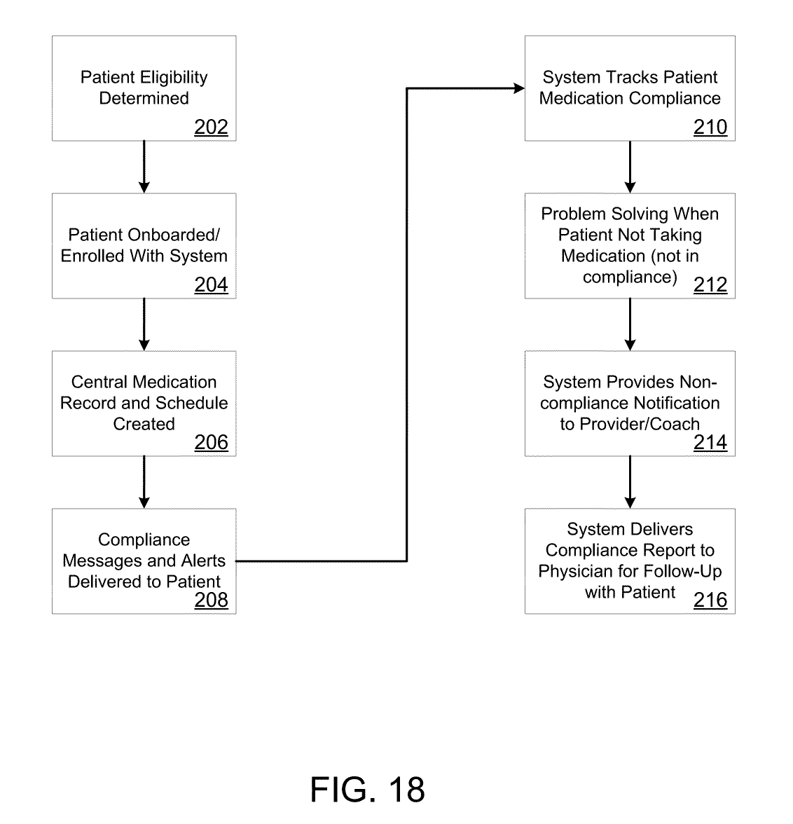

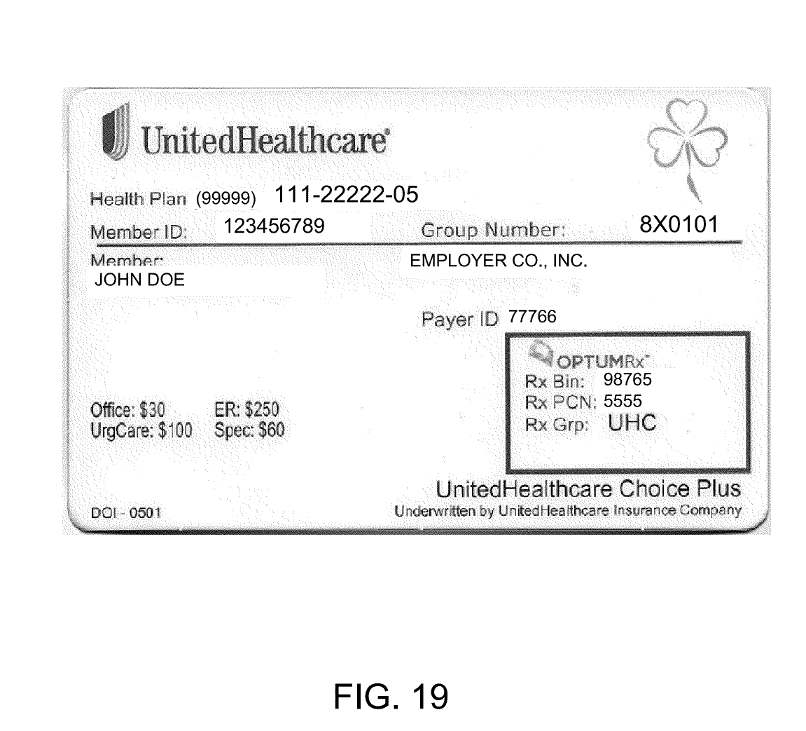

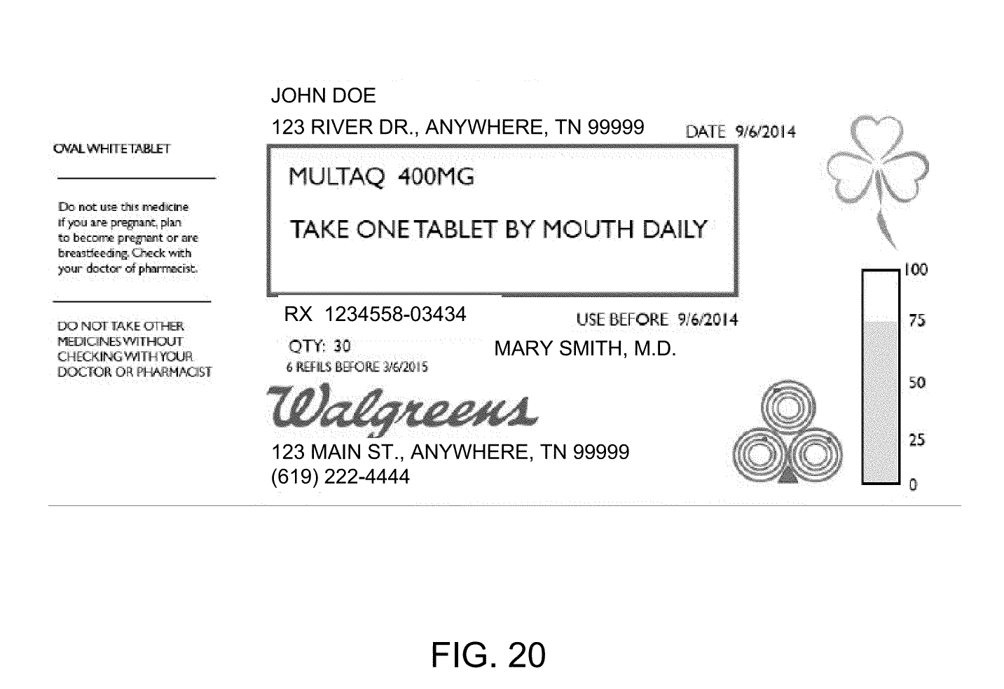

FIGS. 8A to 8C illustrate an example as Comparative Example in which rail stoppers 50 are provided at fixed positions at which the containing cassette is removable. When a user pulls the containing cassette lifting a handle of the containing cassette for the replacement and replenishment of the sheets or pulls the containing cassette suddenly, the containing cassette may be unintendedly removed from the apparatus main body. In such a case, there is a possibility that the containing cassette is damaged, or that the removed containing cassette 1 is damaged when being attached again using force. In some cases, there is also a possibility that inner components may be damaged by a user who may touch them through an opening of the apparatus main body through which the containing cassette has been pulled out.

As compared with Comparative Example, in the present embodiment, if the movable rail stopper 5b is attached to the stopper position illustrated in FIG. 2A, the containing cassette 1 is not able to be removed from the apparatus main body 102. Therefore, unintended removal of the containing cassette 1 is avoided. Further, since the movable rail stopper 5b is movable from the stopper position illustrated in FIG. 2A, it is possible to remove the containing cassette 1 from the apparatus main body 102 when maintenance is necessary.

### Second Embodiment

Next, a pulling device according to a second embodiment of the present invention will be described.

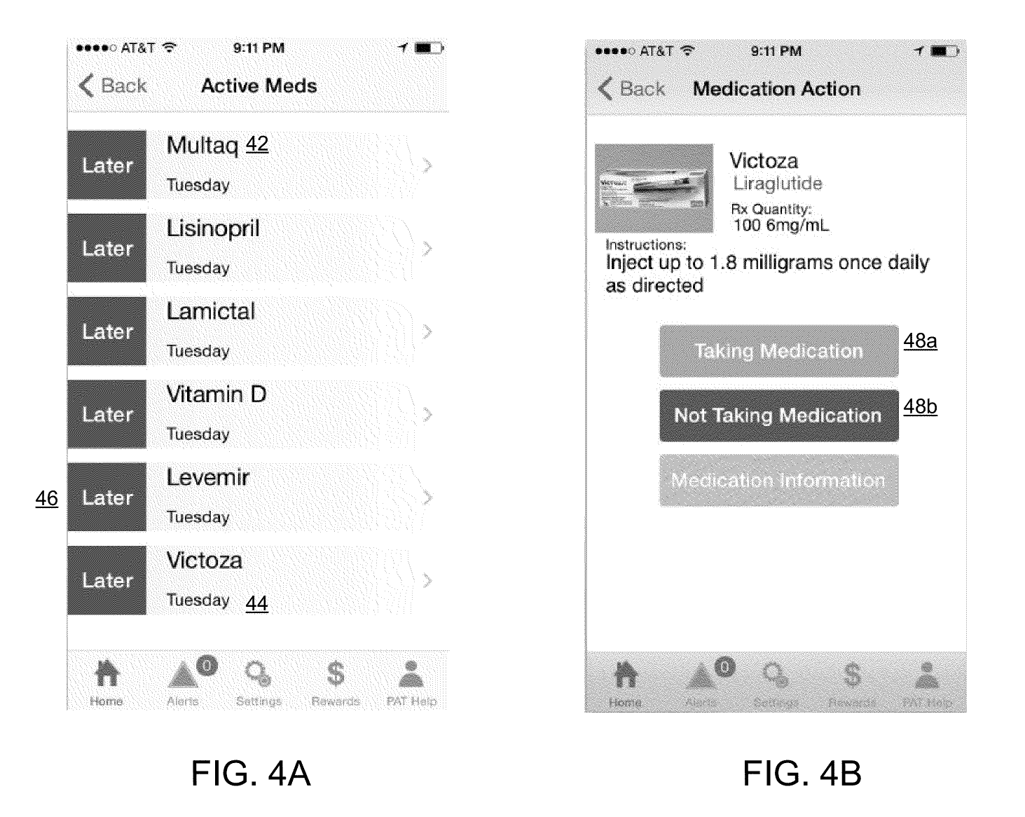

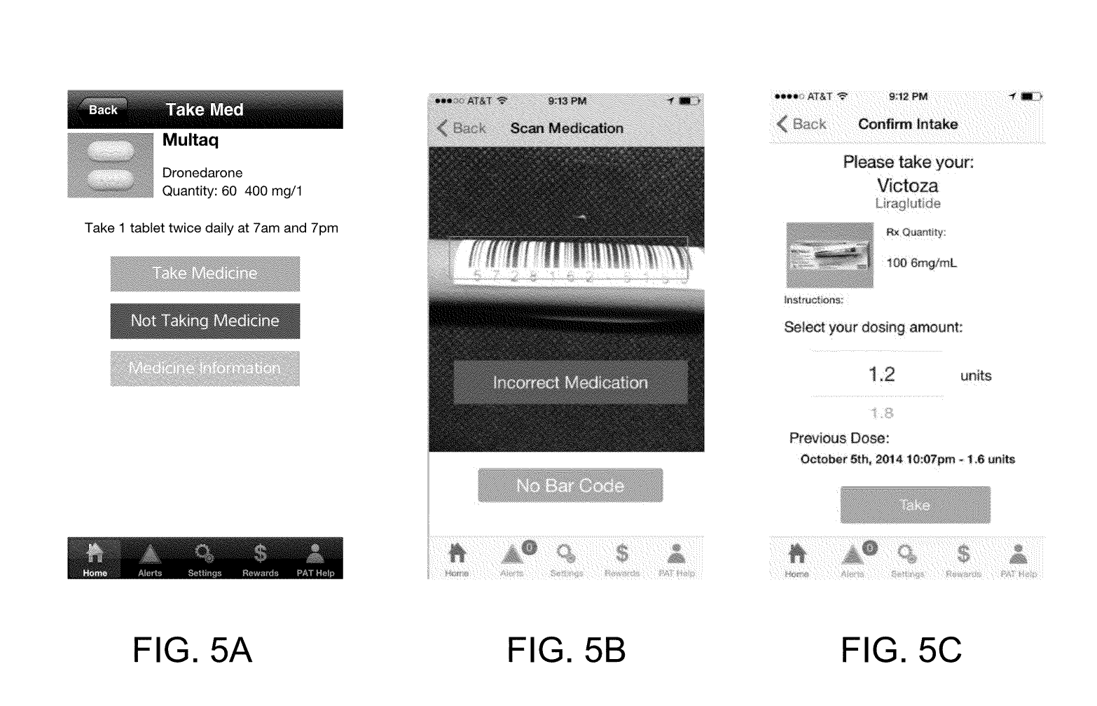

FIGS. 4A and 4B are perspective views illustrating the pulling device of the second embodiment. FIG. 4A illustrates the stopper position and FIG. 4B illustrates the release position of a rail stopper portion. FIGS. 5A, 5B and 5C are explanatory view of an operation of the pulling device of the second embodiment.

An opening 4a is provided in a side surface portion 43 of the guide rail 4 near the movable rail stopper 5b. The movable rail stopper 5b is provided to extend, through the opening 4a, from the outside to the inside (i.e., the side in which the paper cassette 1 is guided) of the guide rail 4. That is, via the side surface portion 43, the movable rail stopper 5b is provided on the side on which the containing cassette 1 is to be attached, and operating unit 47 connected to the movable rail stopper 5b is provided on the side on which the containing cassette 1 is not attached. The operating unit 47 is inserted in the opening 4a from the inside of the guide rail 4 and is disposed outside. The movable rail stopper 5b is disposed inside (i.e., a side on which the containing cassette 1 is guided) the guide rail 4 which has a substantially U-shaped cross section, and the operating unit 47 is disposed outside the guide rail 4 which has a substantially U-shaped cross section.

A fixing plate 46 is attached to the side surface portion 43 at a position corresponding to the stopper position of the movable rail stopper 5. The fixing plate 46 is a plate-shaped member extending perpendicular to the side portion 43 and extending in the vertical direction. A threaded hole 46a is formed in the fixing plate 46.

The operating unit 47 connected to the movable rail stopper 5b is operated by the operator when the movable rail stopper 5b is moved. In the operating unit 47, a knob portion 6 for switching the movable rail stopper 5b between the stopper position and the release position, and a fastening portion 7a for fixing the movable rail stopper 5b to the guide rail 4 at the stopper position are provided. The fastening portion 7a which has a hole through which the fastening member 7b is inserted faces the fixing plate 46. The fastening portion 7a is a portion for fixing the movable rail stopper 5b to the fixing plate 46.

Since the operating unit 47 is disposed outside the guide rail 4 which has a substantially U-shaped cross section, i.e., on the side on which the containing cassette 1 is not attached, the operation by the operator is easy.

In normal use, the movable rail stopper 5b is at the stopper position as illustrated in FIGS. 4A and 5A. The movable rail stopper 5b is fixed to the fixing plate 46 of the guide rail 4 by the fastening member (i.e., the fixing member) 7b which is the screw inserted in the threaded hole 46a. With this configuration, even if the containing cassette 1 is pulled to the maximum pulled position as in the first embodiment, the cassette stopper 3 abuts the rail stopper 5 and further pulling is regulated, whereby removal of the containing cassette 1 from the apparatus main body is avoided.

Next, when the containing cassette 1 is removed from the apparatus main body, the fastening member 7b is removed and fixation of the movable rail stopper 5b is released. Fixation of the movable rail stopper 5b is released by removing the fastening member 7b from the front side of the image forming apparatus using a tool (i.e., a driver).

Then, as illustrated in FIG. 4B, the operator moves the knob portion 6 in the direction of arrow C and moves the movable rail stopper 5b to the release position. At the release position, as in the release position in the first embodiment, the cassette stopper may pass through between the fixed rail stopper 5a and the movable rail stopper 5b as illustrated in FIGS. 5B and 5C. Therefore, the containing cassette 1 may be pulled from the apparatus main body 102 and removed from the apparatus main body 102.

In the present embodiment, the knob portion 6 and the fastening portion 7a for fastening using the fastening member 7b are provided in the movable rail stopper 5b. Since the movable rail stopper 5b is fixed by the fastening member 7b which is a screw, the stopper configuration is higher in robustness than a configuration in which a stopper is positioned without fastening using a fastening member (i.e., a fixing member). Since the operation by the operator to the operating unit 47 is easy, maintainability is high. That is, in the present embodiment, both the robustness and maintainability are high.

In the present embodiment, an example in which the opening 4a is provided in the side surface portion 43 of the guide rail 4 is illustrated. Alternatively, an opening may be provided in the lower guide rail portion 42 of the guide rail 4 and the operating unit 47 may be provided to extend below the guide rail 4.

### Third Embodiment

Next, a pulling device according to the third embodiment of the present invention will be described.

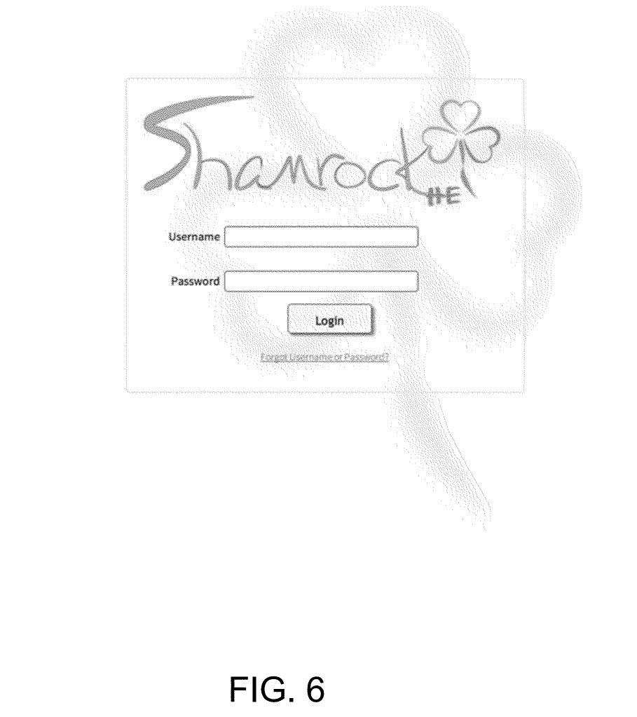

FIGS. 6A and 6B are perspective views illustrating the pulling device of the second embodiment. FIG. 6A illustrates the stopper position and FIG. 6B illustrates the release position of a rail stopper portion.

In the present embodiment, a movable rail stopper 5 may be moved by rotation of a screw as a fastening member without removing the screw. Operations in a normal condition are the same as those of the second embodiment.

Regarding the fastening member 7b which is a screw, in a range of movement between the stopper position and the release position of the movable rail stopper 5, a length of a shaft portion in which a thread groove is formed is set so that screwing with the fixing plate 46 of the guide rail 4 is maintained.

When the containing cassette 1 is removed from the apparatus main body 102, the operator first rotates the screw as the fastening member 7b in a direction to loosen the same using a tool (i.e., a driver) from the front side of the apparatus main body 102. When the fastening member 7b is rotated, the fastening member 7b is moved to the front side of the apparatus main body and, in an interlocked manner, the movable rail stopper 5b is moved in the direction of arrow C which is the direction in which the containing cassette 1 is pulled. Finally, the movable rail stopper 5b reaches the release position where the containing cassette 1 may be pulled and removed from the apparatus main body 102.

The present embodiment has a robust stopper configuration, as in the second embodiment, while the operator may move the rail stopper 5 to the release position by an operation from the front side of the apparatus. Therefore, high robustness and high maintainability are achieved at the same time. Since it is not necessary to remove the screw as the fastening member 7b and the movable rail stopper 5b may be moved by rotating the screw, the operation to move the movable rail stopper 5b is easy.

In the second and third embodiments, examples in which the stopper of the upper guide rail portion 41 is fixed and the stopper of the lower guide rail portion 42 is movable are described. Alternatively, however, the stopper of the lower guide rail portion 42 may be fixed and the stopper of the upper guide rail portion 41 may be movable.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-212750 filed Oct. 10, 2013, which is hereby incorporated by reference herein in its entirety.

What is claimed is:

1. An image forming apparatus comprising:
a containing portion configured to contain a sheet on which an image is to be formed and configured to be slidably supported by an apparatus main body;
a pair of guide rails provided in the apparatus main body and facing each other in an up-down direction, the guide rails being configured to guide a slide movement of the containing portion;
a guide portion provided in the containing portion and guided by the pair of guide rails between the pair of guide rails;
an engaging portion provided at an end portion in a sliding direction of the guide portion, the engaging portion including a projecting portion projecting upward and a projecting portion projecting downward;
a first stopper provided to project from one guide rail of the pair of guide rails toward the other guide rail of the pair of guide rails, and configured to abut the engaging portion to regulate removal of the containing portion from the apparatus main body; and
a second stopper provided to project from the other guide rail toward the one guide rail, and configured to abut the engaging portion to regulate removal of the containing portion from the apparatus main body,
wherein the first stopper is movable in a sliding direction from a position at which removal of the containing portion from the apparatus main body is regulated where a distance between the first stopper and the second stopper is shorter than a thickness in the up-down direction of the engaging portion to a position at which removal of the containing portion from the apparatus main body is released where the distance between the first stopper and the second stopper is longer than the thickness of the engaging portion.

2. The image forming apparatus according to claim 1, further comprising an operating unit that is operated when an operator moves the first stopper, the operating unit being connected to the first stopper.

3. The image forming apparatus according to claim 2, further comprising: a guide unit which includes the pair of guide rails and a side surface portion which connects the pair of guide rails, the guide unit having a substantially U-shaped cross section,
wherein the operating unit is provided outside the guide unit formed in the substantially U-shape.

4. The image forming apparatus according to claim 3, wherein the operating unit is provided outside the guide unit through an opening provided in the side surface portion.

5. The image forming apparatus according to claim 3, wherein the operating unit is provided outside the guide unit through an opening formed in one of the pair of guide rails.

6. The image forming apparatus according to claim 2, wherein the operating unit includes a fixing member for fixing the first stopper at a position at which removal from the apparatus main body is regulated.

7. The image forming apparatus according to claim 6, wherein the fixing member is a screw disposed between the first stopper and the apparatus main body.

8. The image forming apparatus according to claim 7, wherein the first stopper is moved from the position at which removal of the containing portion from the apparatus main body is regulated to the position at which removal of the containing portion from the apparatus main body is released by rotating the screw.

9. The image forming apparatus according to claim 2, wherein the operating unit is provided so as to be operated from a direction in which the containing portion is pulled.

10. An image forming apparatus, comprising:
a containing portion configured to contain a sheet on which an image is to be formed and configured to be detachably attached to an apparatus main body;
a pair of guide rails provided in the apparatus main body, and configured to guide pulling of the containing portion;
a guide portion provided in the containing portion and guided by the pair of guide rails between the pair of guide rails;
a first stopper provided in one guide rail of the pair of guide rails to project toward the other guide rail of the pair of guide rails;
a second stopper provided in the other guide rail to project toward the one guide rail;
a pair of projecting portions provided in the guide portion to project upward and downward, the projecting portions engaging the first stopper and the second stopper so as to regulate removal of the containing portion from the apparatus main body; and
a screw configured to fix the first stopper and, to move the first stopper by being rotated.

11. The image forming apparatus according to claim 10,
wherein the screw causes, when being rotated, the first stopper to move along a direction in which the containing portion is pulled.

12. The image forming apparatus according to claim 10, further comprising: a guide unit which includes the pair of guide rails and a side surface portion which connects the pair of guide rails, the guide unit having a substantially U-shaped cross section, and
a fastening portion connected to the first stopper, provided to extend outside the guide unit from an opening formed in the guide unit, and fastened by the screw to fix the first stopper.

13. An image forming apparatus comprising:
a containing portion configured to contain a sheet on which an image is to be formed and configured to be slidably supported by an apparatus main body;
a pair of guide rails provided in the apparatus main body and facing each other in an up-down direction, the guide rails being configured to guide a slide movement of the containing portion;
an engaging portion provided in the containing portion;
a first stopper provided to project from one guide rail of the pair of guide rails toward the other guide rail of the pair of guide rails, and configured to abut the engaging portion to regulate removal of the containing portion from the apparatus main body; and
a second stopper provided to project from the other guide rail toward the one guide rail, and configured to abut the engaging portion to regulate removal of the containing portion from the apparatus main body,
wherein the first stopper is movable from a position where a distance between the first stopper and the second stopper is shorter than a thickness in the up-down direction of the engaging portion to a position where the distance between the first stopper and the second stopper is longer than the thickness of the engaging portion.

14. The image forming apparatus according to claim 13, further comprising an operating unit that is operated when an operator moves the first stopper, the operating unit being connected to the first stopper.

15. The image forming apparatus according to claim 14, comprising: a guide unit which includes the pair of guide rails and a side surface portion which connects the pair of guide rails, the guide unit having a substantially U-shaped cross section,
wherein the operating unit is provided outside the guide unit formed in the substantially U-shape.

16. The image forming apparatus according to claim 15, wherein the operating unit is provided outside the guide unit through an opening provided in the side surface portion.

17. The image forming apparatus according to claim 15, wherein the operating unit is provided outside the guide unit through an opening formed in one of the pair of guide rails.

18. The image forming apparatus according to claim 14, wherein the operating unit includes a fixing member for fixing the first stopper at a position at which removal from the apparatus main body is regulated.

19. The image forming apparatus according to claim 18, wherein the fixing member is a screw disposed between the first stopper and the apparatus main body.

20. The image forming apparatus according to claim 19, wherein the first stopper is moved from the position at which removal of the containing portion from the apparatus main body is regulated to the position at which removal of the containing portion from the apparatus main body is released by rotating the screw.
